(19) United States
(12) Patent Application Publication
(10) Pub. No.: US 2014/0295099 A1
(43) Pub. Date: Oct. 2, 2014

(54) LIQUID COATING, COATED FILM AND PROCESS FOR COATING FILM

(71) Applicant: Klockner Pentaplast of America, Inc., Gordonsville, VA (US)

(72) Inventors: Carrie Napper, Gordonsville, VA (US); William Crawford, Gordonsville, VA (US)

(73) Assignee: Klockner Pentaplast of America, Inc., Gordonsville, VA (US)

(21) Appl. No.: 14/218,304

(22) Filed: Mar. 18, 2014

Related U.S. Application Data
(60) Provisional application No. 61/805,730, filed on Mar. 27, 2013.
(60) Provisional application No. 61/806,032, filed on Mar. 28, 2013.

(51) Int. Cl. C09D 175/04; C09D 133/00; C08J 7/04; B05D 3/00

(52) U.S. Cl. CPC C09D 175/04; B05D 3/007; C09D 133/00; C08J 7/047; C08J 2475/04; C08J 2433/00
USPC 427/542; 427/372.2; 427/385.5; 427/384; 427/393.5; 524/507; 524/501

(57) ABSTRACT

A system, a method, a device, an article of manufacture, a liquid coating, a computer program manufacturing a liquid coating, and a computer program for coating a film and making a coated film product for use with digital printers.

### CROSS REFERENCE TO PRIOR APPLICATION

This application claims priority to and the benefit thereof from U.S. provisional patent application No. 61/806,032, filed Mar. 28, 2013, titled “Liquid Coating, Coated Film, and Process for Coating Film”, and U.S. provisional patent application No. 61/805,730, filed Mar. 27, 2013, titled “Coated Film and Process for Coating Film”, the entireties of which are hereby incorporated herein by reference.

### FIELD OF THE DISCLOSURE

The present disclosure relates to a system, a method, a device, a formulation, an article of manufacture and a computer program. More particularly, the present disclosure relates to a system, a method, a device, a formulation, an article of manufacture, and a computer program for coating a film and making a coated film product.

### BACKGROUND OF THE DISCLOSURE

Polyethylene terephthalate (PET), a thermoplastic polymer resin, and other polyesters are commonly used for a wide variety of applications, including, for example, synthetic fibers, textiles, beverage, food and other liquid containers, shrink-wrap films, and the like. For instance, biaxially oriented PET film can be aluminized by, e.g., evaporating a thin film of metal onto the film to make it reflective and opaque. Further, amorphous PET (or PETG) is frequently used in shrink-film applications. However, conventional PET films have had limited applications in digital printing, since conventional films have not been receptive to inks (e.g., Indigo ink) used in digital printing technologies.

Digital printing methods typically include printing digital-based images directly to a variety of materials, such as, e.g., paper, photo paper, canvas, glass, metal, marble, and the like. The printing is frequently done by, e.g., inkjet printers, laser printers, and the like, which deposit, e.g., pigment, toner, and the like. In many processes, the ink or toner does not permeate the material, but forms a thin layer on the surface of the material, which may be adhered or fixed to the surface by means of, e.g., a fuser fluid with heat process (e.g., toner), an ultraviolet (UV) process (e.g., ink), or the like. In the case of conventional thermoplastic polymer films (e.g., PET films, PVC films, or the like), digital printing methods have not been able to effectively print digital images onto the films. For example, Indigo ink, which is commonly used in certain digital printers (such as, e.g., Hewlett Packard digital printers), tends to smudge, leak, not adhere to the film, or the like, when applied to a surface of a thermoplastic polymer film.

There is an unfulfilled need for a coating that can be applied to a substrate for e.g., digital printing. Accordingly, this disclosure provides a novel system, method, device, a liquid coating formulation, an article of manufacture, a computer program for manufacturing a liquid coating, and a computer program for coating a film and making a coated film product that may be used in, e.g., digital printing technology.

### SUMMARY OF THE DISCLOSURE

The disclosure provides non-limiting examples of a system, a method, a device, a liquid coating formulation, an article of manufacture, a computer program for manufacturing a liquid coating, and a computer program for coating a film and making a coated film product that may be used in, e.g., digital printing technology.

According to an aspect of the disclosure, a novel coating is provided. The coating includes a low volatile organic compound (VOC), water-based ammoniated polyurethane/acrylic blended digital print receptive coating formulation with a nonionic surfactant to serve as a wetting and defoaming agent that, when coated and dried to a desired substrate (e.g., PET, PETG, PVC, and the like), will allow full color digital printing and graphics. The coating may allow high speed digital ink printing to materials such as, e.g., a thin gauge clear film which may subsequently be formed from a desired substrate. The thin gauge clear film may be utilized in, e.g., a conventional shrink sleeve manufacturing process. The coating may be formulated as a liquid coating that can be smoothly and uniformly coated on a substrate surface utilizing multiple processes such as, e.g., Meyer Rod, Reverse Roller, Gravure coater, Gap coater, Slot die coater, Curtain coater, Air knife coater, and the like. The coating may be manufactured by means of a method of manufacturing a liquid coating. The method of manufacturing a liquid coating may be computerized, wherein a computer may cause all (or some) of the steps of the manufacturing method to be carried out.

According to a further aspect of the disclosure, a method of manufacturing a liquid coating includes providing a vessel, introducing an appropriate amount of H₂O into the vessel, introducing an appropriate amount of Digiprime 4431 into the vessel, introducing an appropriate amount of NeoCryl XK-90 into the vessel, mixing the contents of the vessel for a first predetermined length of time, slowly delivering Surfynol 440 into the vessel while mixing the contents of the vessel, and continuing the mix the contents of the vessel for a second predetermined length of time. The vessel may include, e.g., a 55 gallon fiber board drum, a 275 gallon plastic tote, or the like. If using a drum, the vessel may be placed on, e.g., a prebuilt skid prior to introducing the H₂O. The H₂O may be introduced into the vessel at room temperature.

According to an embodiment of the disclosure, the first predetermined length of time may include about 10 minutes and the second predetermined length of time may include about 30 minutes. The method of manufacturing the liquid coating may be entirely (or partially) computerized, with each (or some) step(s) being carried out by or under the control of a computer.

The Digiprime 4431 may be filtered prior to being introduced into the vessel. For instance, the Digiprime 4431 may be filtered by means of a 250 micron mesh filter prior to being introduced into the vessel. The Digiprime 4431 may be introduced into the vessel by means of, e.g., a diaphragm, a pump, a pumping system, or the like.

The NeoCryl XK-90 may be filtered prior to being introduced into the vessel. For instance, the NeoCryl XK-90 may be filtered by means of a 250 micron mesh filter prior to being introduced into the vessel. The NeoCryl XK-90 may be introduced into the vessel by means of, e.g., a releasing valve on the tote that allows raw material to gravity feed through a pre-attached corrugated hose.

The contents of the vessel may be mixed by means of a mixer. The mixer may include, e.g., a three blade, dual propeller mixer capable of about 1750 rpm that may be inserted into the vessel and operated to effectively mix the contents in the vessel.

At the conclusion of the method of manufacturing the liquid coating, the contents of the vessel may be output as a liquid coating that is ready for application to, e.g., a thermoplastic polymer (TPP) film for digital printing applications. The TPP film may include, e.g., PETG, PVC, and the like. Both the TPP film and liquid coating may be clear when the liquid coating is applied to a surface of the TPP film and coated film is allowed to dry into a coated clear (CC) film.

The liquid coating may include the final attributes of about 6.9% solids, a viscosity of about 1.43 cps, and a pH level in the range of about 7 pH to about 9 pH.

According to a still further aspect of the disclosure, the liquid coating may be applied to a surface of, e.g., a thin gauge (e.g., about 25 micron to about 250 micron) substrate e.g., TPP film (e.g., PETG, PVC, or the like) to provide a CC film. The CC film may be cross-direction stretched by means of, e.g., a Tenter Frame. The CC film may exhibit known shrinkage in a controlled heated environment (e.g., like an oven), which may be suitable for, e.g., bottle and package labeling. One or more surfaces of the CC film may receive digital inks to allow full color printing and graphics. The coating, as well as the CC film, has performance properties such that the CC film can be high speed printed with, e.g., digital ink printers and processed into, e.g., a seamed tube (sleeve) using conventional sleeve label manufacturing processes and then affixed to the bottle or packaged product to provide labeling or protection.

An embodiment of the CC film may include, e.g., a Klöckner Pentaplast (or equivalent) 50 micron thick clear transverse directional oriented PETG polymeric film with a 0.10 dry grams per square meter (gsm) coatweight of, e.g., Klöckner Pentaplast W45 coating (or equivalent). The coatweight of the applied ink receptive coating may be metered to be precise in quantity using a preferred coating methodology.

The coatweight may be applied in a range of, e.g., about 0.03 gsm to about 1.00 gsm, preferably about 0.08 gsm to about 0.16 gsm, and more preferably about 0.08 gsm to provide performance properties discussed later.

Alternatively (or additionally), the coating may include, e.g., a clear urethane, acrylic, latex, or other polymer emulsion manufactured by e.g., Michelman Digiprime, LexTech, HP Topaz, HP Sapphire, Utopia, Wausau Coated Products, Masterpiece Graphix, or the like.

Alternative substrates may include, e.g., clear transverse directional oriented PETG polymeric film, clear and colored PVC, clear and pigmented PETG, clear and pigmented APET, and multilayer constructions of any and all polymer films that exhibit heat shrink characteristics. Substrate material manufacturers may include, e.g., Bonset, Fuji Film, SKC, Mitsubishi, or the like.

According to a further aspect of the disclosure, the CC film may be made by applying a liquid coating onto the thermoplastic polymer (TPP) film. The liquid coating may be coated onto the TPP film by means of, e.g., a Meyer Rod, a Reverse Roll, a three roll Dahlgren, a Gravure coater, or the like, laying down a smooth, even coatweight of the liquid coating on the TPP film. The application coatweight should be consistent along the entire web path, as well as transversely across the web within, e.g., about +/−50% of a target coatweight.

The liquid coating may be delivered to the coating equipment in a mixed and homogeneous matter. The coating equipment may include offline machinery manufactured by, e.g., Polytype, Faustel, Kohler, or the like. The coating equipment may include, e.g., Tenter Frame stretch equipment that will allow for an on-line coating opportunity. The coating head equipment may include, e.g., a Meyer Rod coating station, a Tenter Frame coating station, Gravure coating station, Gap coating station, Slot Die coating station, Curtain coating station, Air Knife coating station, and the like.

According to a still further aspect of the disclosure, the article of manufacture may include a CC film. The CC film may include certain properties and characteristics that allow for its use in, e.g., the digital printing and labeling industry. These properties include:
Clarity—the coated product (CC film), at the coating weight disclosed herein, should exhibit a light transparency and reflectance equal to or within, e.g., about +/−20% of the uncoated film. A 20 degree gloss level measured with ASTM D523 in a range from, e.g., about 80 to about 150, preferably about 95 to about 125, and more preferably 110 for the CC film. The CC film should have a haze that is substantially the same as the uncoated TPP film that is included in the CC film. The CC film should exhibit haze measured with ASTM D1003 of, e.g., about 0 to about 10, preferably about 0 to about 6, and more preferably about 0 to about 3.
Coefficient of Friction—The CC film should have a coefficient of friction in a measureable range of, e.g., about 0.15 to about 0.28 using ASTM D1894.
Digital Ink Blanket transfer—The CC film should have sufficient positive surface charge such that, e.g., toner-based digital inks may transfer from a print blanket to the print substrate (TPP film). RIT (Rochester Institute of Technology), HP, and others may perform the necessary tests to determine the acceptance criteria.
Ink tape test—The CC film, after printing, may pass, e.g., a 3M 600 tape test in accordance with RIT methods and criteria.
Fixing—The CC film, after printing, may allow, e.g., an ink to cure and set such that additional processes can be possible without scuffing the ink and causing ink falloff and pinholes in the image.
Seaming after coating—The CC film may process in, e.g., a commercial high speed seaming operation through Stanford, DCM, Karlville, or similar equipment, or similar, to the extent commercial solvents bond the film at speeds of, e.g., about 50 to about 200 meters per minute. The CC film may be compatible with a variety of solvents, including, e.g., THF, MEK, to the extent that a bond of the films can be tested to a level of, e.g., about 10N/cm bond strength or greater.
Block resistant—the CC film may have sufficient dry tack and hardness to resist blocking or tacking in roll form to unwind at commercial speeds without ripping out and tearing the web. The test method may include, e.g., placing stacked sheets 5×8 inch under 40 pounds pressure in an 150° F. elevated temperature environment for five days, or placing stacked sheets 5.5×8 inch under 50 pounds pressure in an 120° F. elevated temperature environment for five days, resulting in ease of removal.
Process ability—The CC film may have physical properties that will not be a detriment to, e.g., high speed label processing. This may include properties, such as, e.g., tensile, elongation, stiffness, slip, antistatic, coefficient of expansion and contraction, flammability, resistance to heat, impact strength, coefficient of friction, or the like.
Shrink curve effect minimal—The CC film may exhibit a shrink curve (% shrink vs temperature) within, e.g., about 95% of the uncoated substrate approved for this process.
Coat weight consistency—The CC film may be measured to have been applied with, e.g., a 0.10 dry gsm coatweight +/−50% using a gravimetric test method in all areas of the article of manufacture (product). Further, the applied coatweight may be in a range of, e.g., about 0.03 gsm to about 1.00 gsm. preferably about 0.08 gsm to about 0.16 gsm, and more preferably about 0.08 gsm.

According to a yet further aspect of the disclosure, the computer program may be embodied in or recorded on a computer readable medium that, when executed on a computer, may cause coating equipment to manufacture CC film by receiving a TPP film and coating the TPP film with a liquid coating as described herein. The computer readable medium may include a code section or code segment for carrying out each step of the coating processes described herein.

According to still further aspect of the disclosure, a coating process is provided for manufacturing the CC film. The coating process includes conveying a web substrate (e.g., TPP film) across the coating equipment at an even and controlled tension, applying a liquid coating to the web substrate, and drying the coated web substrate (e.g., by means of a forced air gas fired drying tunnel, or the like).

The coating process may include applying a force of, e.g., about 0.5 to about 1.5 lbs per inch width of substrate web when conveying the web substrate across the coating equipment. It is noted that lower or greater forces may be achievable by the coating process.

The coating process may comprise applying sufficient BTU energy to dry the coated W45, or similar, CC film to reduce the VOC or residual moisture content to a level of, e.g., about 5%+/−4% at any desired speed. Alternatively (or additionally), the coating process may include application of infrared energy to dry a water-based coating, such as, e.g., Klöckner Pentaplast (kp) W45. The coating process may achieve speeds in the range of, e.g., about 10 feet per minute to about 350 feet per minute. It is noted that lower or greater speeds may be achievable by the coating process.

The coating process may further comprise a rheology adjustment of the liquid coating to achieve a desired result. Additives such as, e.g., water, alcohol, or surfactant may be included in percentages of the ppr of, e.g., about 0.1 to about 20% by weight. It is noted that lower or greater speeds may be achievable by the coating process.

Additional features, advantages, and embodiments of the disclosure may be set forth or apparent from consideration of the detailed description and drawings. Moreover, it is to be understood that the foregoing summary of the disclosure and the following detailed description and drawings are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a process for manufacturing a liquid coating, according to the principles of the disclosure.

FIG. 2 shows an example of a system for making a thin gauge coated clear film, according to the principles of the disclosure.

FIG. 3 shows an example of a Meyer Rod coating station that may be included in, e.g., the system of FIG. 2.

FIG. 4 shows an example of a Tenter Frame coating station that may be included in, e.g., the system of FIG. 2.

FIG. 5 shows an example of a Tenter Frame being implemented to stretch a thin gauge coated clear film, according to the principles of the disclosure.

FIG. 6 shows an example of a coated clear film manufacturing line, according to the principles of the disclosure.

The present disclosure is further described in the detailed description and attachment that follow.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

According to an aspect of the disclosure, a novel coating is provided. The coating comprises a low volatile organic compound (VOC), water-based ammoniated polyurethane/acrylic blended digital print receptive coating formulation with a nonionic surfactant to serve as a wetting and defoaming agent that, when coated and dried to a desired substrate (e.g., PET, PETG, PVC, APET, or the like), will allow full color digital printing and graphics. The coating may allow high speed digital ink printing to materials such as, e.g., a thin gauge clear film that can later be utilized in a conventional shrink sleeve manufacturing process. The coating may be formulated as a liquid coating that can be smoothly and uniformly coated on a substrate surface utilizing at least one process such as, e.g., Meyer Rod coating, Reverse Roll coating, Gravure coating, Gap coating, Slot Die coating, Immersion coating, Curtain coating, Air Knife coating, and the like. The coating may be manufactured by means of a method of manufacturing a liquid coating.

The liquid coating of the present disclosure will be illustrated in greater detail in the following non-limiting examples.

### Example 1

W45 Formulation

| % by | | Component | Component |
|---|---|---|---|
| Weight | Component | Manufacturer | Description |
| 83.101 | H2O | N/A | N/A |
| 8.275 | Digiprime 4431 | Michelman | Ammoniated |
| | | | polyurethane |
| 8.275 | NeoCryl XK-90 | DSM NeoResins | Acrylic |
| | | | emulsion |
| 0.15 | Surfynol 440 | Air Products | Nonionic |
| | | | surfactant |
| 0.199 | Preventol P-91 | LanXess | Preservative |

Coating weights may include, e.g., about 0.05 pound/ream, about 0.10 pound/ream, or the like.

Experimental Laboratory Tests

50% W45 below/50% H20—Various coating weights
35% W45 below/65% H20—Various coating weights
30% W45 below/70% H20—Various coating weights
20%/W45 below/80% H20—Various coating weights
30% W45 below/70% H20/0.10% Surfynol 440—Various coating weights
20% W45 below/80% H20/0.10% Surfynol 440—Various coating weights

### Example 2

W45 Formulation

| % by | | Component | Component |
|---|---|---|---|
| Weight | Component | Manufacturer | Description |
| 83.101 | H2O | N/A | N/A |
| 8.275 | Digiprime 4431 | Michelman | Ammoniated |
| | | | polyurethane |
| 8.275 | Primacoat | Henkel | Polyurethane |
| | WWA-06-E5 | | |
| 0.15 | Surfynol 440 | Air Products | Nonionic |
| | | | surfactant |
| 0.199 Post-Add | Preventol P-91 | LanXess | Preservative |

Coating weight may include, e.g., about 0.18 pound/ream.

### Example 3

Digiprime 4431

| % by | | Component | Component |
|---|---|---|---|
| Weight | Component | Manufacturer | Description |
| 100 | Digiprime 4431 | Michelman | Ammoniated |
| | | | polyurethane |

Coating Weight may include, e.g., about 0.12 pound/ream.

Alternative Experimental Formulations Made

W45 Formulation

| % by | | Component | Component |
|---|---|---|---|
| Weight | Component | Manufacturer | Description |
| 16.683 | H2O | N/A | N/A |
| 41.335 | Digiprime 4431 | Michelman | Ammoniated |
| | | | polyurethane |
| 41.335 | Primacoat | Henkel | Polyurethane |
| | WWA-06-E5 | | |
| 0.448 | Surfynol 440 | Air Products | Nonionic |
| | | | surfactant |
| 0.199 Post-Add | Preventol P-91 | LanXess | Preservative |

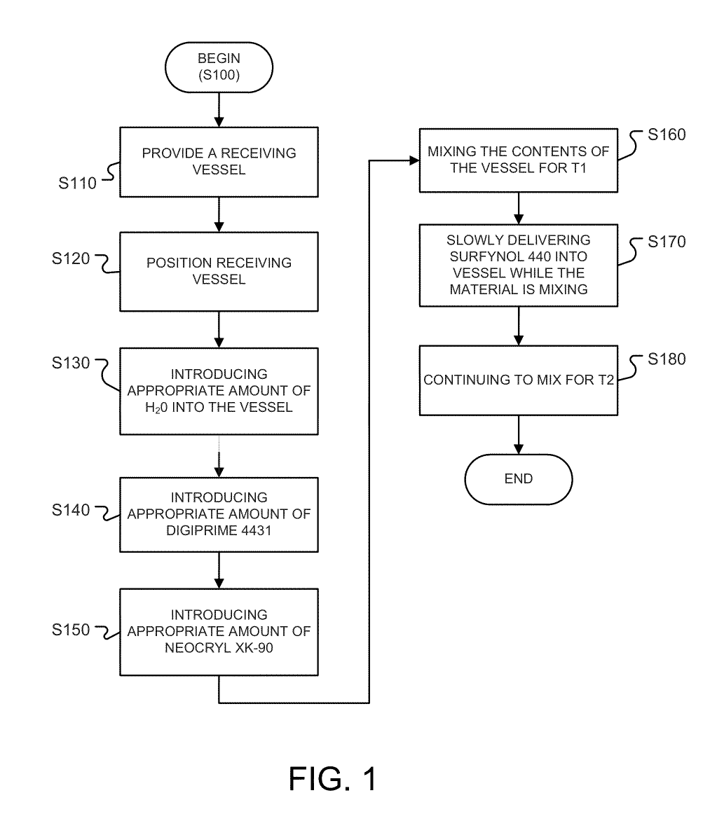

FIG. 1 shows an example of a method of manufacturing the liquid coating. The method includes providing a receiving vessel (such as, e.g., a 55 gallon fiber board drum, a 275 gallon plastic tote, and the like) (Step 110) and positioning the vessel (Step 120). If the receiving vessel comprises a drum, then the process of positioning the vessel (Step 120) may include placing the vessel on, e.g., a prebuilt skid and taring the vessel (Step 120). The method further includes introducing an appropriate amount of H₂O into the vessel (Step 130), and introducing an appropriate amount of Digiprime 4431 into the vessel (S140), and introducing an appropriate amount of NeoCryl XK-90 into the vessel (Step 150). Any one or more of the H₂O, Digiprime 4431, and/or NeoCryl XK-90 4431 may be at room temperature.

The contents of the vessel may be mixed for time T1 (Step 160). Surfynol 440 may be delivered into the vessel while mixing the contents of the vessel (Step 170). Surfynol 440 may be delivered into the vessel while the contents are mixed for T2 (Step 180). Time T1 may include, e.g., about 10 minutes and time T2 may include, e.g., about 30 minutes.

The Digiprime 4431 may be filtered prior to being introduced into the vessel (Step 140). For instance, the Digiprime 4431 may be filtered by means of a 250 micron mesh filter prior to being introduced into the vessel. The Digiprime 4431 may be introduced into the vessel by means of, e.g., a diaphragm, a pump, a pumping system, or the like.

The NeoCryl XK-90 may be filtered prior to being introduced into the vessel (Step 150). For instance, the NeoCryl XK-90 may be filtered by means of a 250 micron mesh filter prior to being introduced into the vessel. The NeoCryl XK-90 may be introduced into the vessel by means of, e.g., a releasing valve on the tote that allows raw material to gravity feed through a pre-attached corrugated hose.

The contents of the vessel may be mixed by means of a mixer (Step 160). The mixer may include, e.g., a three blade, dual propeller mixer capable of about 1750 rpm that may be inserted into the vessel and operated to effectively mix the contents in the vessel.

At the conclusion of the method of manufacturing the liquid coating, the contents of the vessel may be output as a liquid coating that is ready for application to a substrate, such as, e.g., a thermoplastic polymer (TPP) film, which may be utilized for digital printing applications. Both the substrate and liquid coating may be clear when the liquid coating is applied to a surface of the substrate. The resulting coated substrate may be allowed to dry into a coated clear (CC) film.

The method of manufacturing the liquid coating may be entirely (or partially) automated, with each (or some) step(s) being carried out by a computer (not shown). For instance all (or some) of the steps shown in FIG. 1 may be carried out by or under the control of a computer.

The liquid coating may include final attributes of, e.g., about 6.9% solids, a viscosity of about 1.43 cps, and a pH level in the range of about 7 pH to about 9 pH.

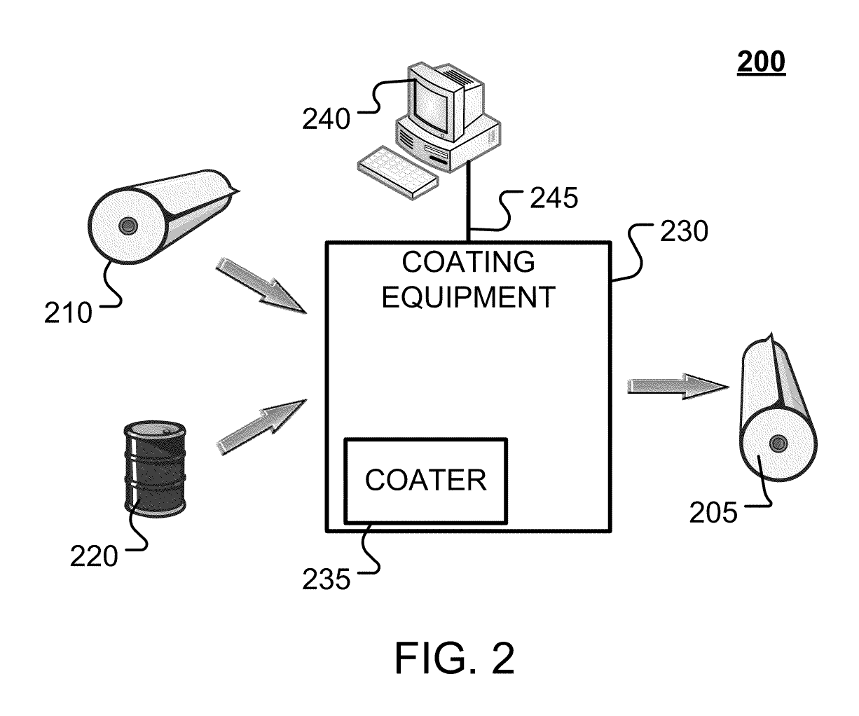

FIG. 2 shows an example of a system 200 for making a thin gauge coated clear (CC) film 205 according to the principles of the disclosure. The system 200 includes coating equipment 230. The system 200 may include a computer 240 that is coupled to the coating equipment 230 via a communication link 245.

The computer 240 may include or may be communicatively coupled to a database (not shown) that may include substrate data, liquid formulation data, coated clear (CC) film data, coating equipment data, customer data, shipping data, and the like. The substrate data may include, e.g., film type data, film length data, film width data, film weight data, film thickness data, film tensile strength data, seaming data, shrink curve effect data, coefficient of friction data, and the like. The liquid formulation data may include, e.g., coat weight data, drying characteristics data, viscosity data, temperature data, pressure data, and the like. The CC film data may include, e.g., clarity data, coefficient of friction data, digital ink blanket transfer data, ink tape test data, fixing data, seaming after coating data, block resistant data, process ability data, shrink curve effect data, coat weight consistency data, and the like. The coating equipment data may include, e.g., coating equipment type data, equipment manufacturer data, year of equipment manufacture data, brand name data, model number data, location data, and the like. The customer data may include, e.g., customer name data, customer address data, customer account data, and the like. The shipping data may comprise, e.g., shipping order data, delivery date data, shipping location data, and the like.

The computer 240 may be coupled to one or more customers and/or suppliers by means of communication links 245. The computer 240 may be coupled to the customers and/or suppliers over a network. The computer 240 may be configured to receive and fill orders from customers, as well as to order and receive supplies and/or services from suppliers.

The computer 240 may further include a user interface (not shown) where a user (e.g., a manager, a manufacturer, a designer, an operator, and the like) may input or load instructions (e.g., substrate data, liquid formulation data, coated clear film data, coating equipment data, customer data, shipping data, and the like). The instructions may be sent in real-time to the coating equipment 230 via communication links 245.

The computer 240 and the coating equipment 230 may each include a computer readable medium including a computer program that may be executed by the computer 240 to carry out coating process disclosed herein. The computer-readable medium may include a code or code segment for performing each step disclosed herein, including Steps 110 to 180. The coating process may be carried out by or under the control of the computer 240 or manually by a user. The coating process may include, e.g., the liquid coating manufacturing process shown in FIG. 1.

The system 200 is configured to receive a substrate 210 (e.g., a thermoplastic polymer film web) and a liquid coating 220 and to output the coated clear (CC) film 205. The coating equipment 230 may include, e.g., a Tenter Frame, or the like. The coating equipment 230 may include a coater 235 that is configured to receive the liquid coating 220 and to apply the liquid coating 220 to the substrate 210.

Referring to FIG. 2, the coating process may include conveying a substrate 210 (e.g., a TPP film web) across the coating equipment 230 at a substantially even and controlled tension, applying the liquid coating 220 to the substrate; and drying the coated substrate 210/220 (e.g., by means of a forced air gas fired drying tunnel, or the like). The coating equipment 230 may be controlled to apply a force of, e.g., about 0.5 to about 1.5 lbs. per inch width of substrate 210 when conveying the substrate 210 across the coating equipment 230. It is noted that lower or greater forces may be achievable by the coating equipment 230.

The coating equipment 230 may apply the liquid coating 220 onto the substrate 210 (e.g., TPP film web) by means of a coater 235 (such as, e.g., a Meyer Rod, a Reverse Roll, a three roll Dahlgren, a Gravure coater, a Slot Die coater, a Curtain coater, an Air Knife coater, and the like) laying down a smooth, even coatweight of the liquid coating 220 on the substrate 210. The application coatweight should be consistent along the entire web path, as well as transversely across the web within, e.g., about +/−50% of a target coatweight.

The liquid coating 220 may be delivered to the coating equipment 230 in a mixed and homogeneous matter. The coating equipment 230 may include offline machinery manufactured by, e.g., Polytype, Faustel, Kohler, or the like. The coating equipment 230 may include, e.g., Tenter Frame stretch equipment that will allow for an on-line coating opportunity. The coating equipment 230 may include, e.g., a Meyer Rod coating station, a Tenter Frame coating station, a Gravure coating station, a Gap coating station, a Slot Die coating station, a Curtain coating station, an Air Knife coating station, and the like. The coater 235 may be provided upstream of and affixed to, e.g., a Tenter Frame, or the like, to apply a layer of the liquid coating to the substrate prior to stretching in the Tenter Frame.

Alternatively, the coater 235 may be configured to apply the liquid coating to the substrate after it has already been stretched in the Tenter Frame.

The coating equipment 230 may be controlled/caused to apply sufficient BTU energy to dry, e.g., coated W45, or similar, CC film to reduce the volatile organic compound (VOC) or residual moisture content to a level of, e.g., about 5%+/−4% at any desired speed. Alternatively (or additionally), the coating equipment 230 may include application of infrared energy to dry a water-based coating, such as, e.g., Klöckner Pentaplast (kp) W45. The coating equipment 230 may achieve speeds in the range of, e.g., about 10 feet per minute to about 350 feet per minute. It is noted that lower or greater speeds may be achievable by the coating equipment.

The coating equipment 230 may further include a rheology adjustment of the liquid coating to achieve a desired result. Additives such as, e.g., water, alcohol, or surfactant may be included in the formula of about 0.1 to about 20% by weight. It is noted that lower or greater coating weights may be achievable by the coating process.

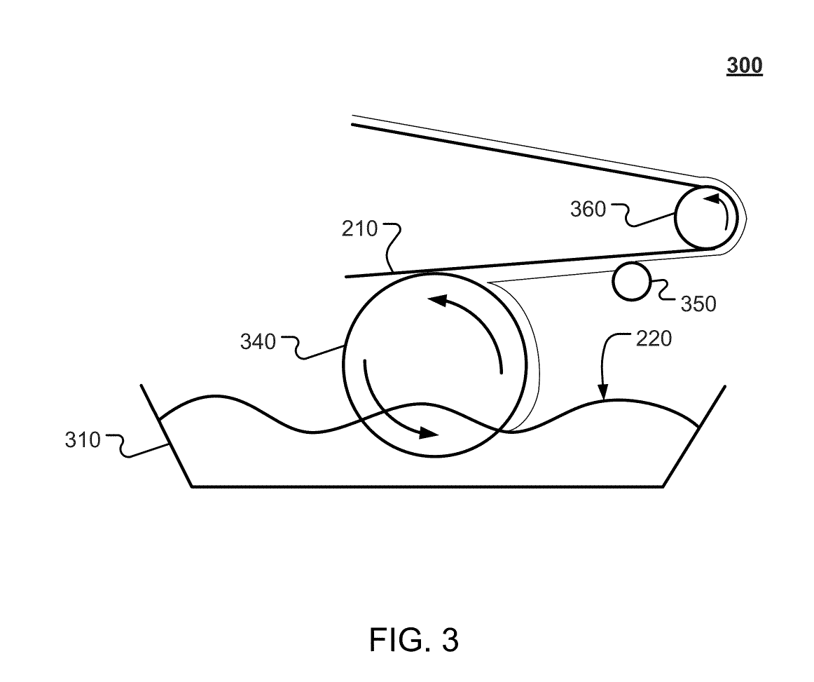

FIG. 3 shows an example of a Meyer Rod coating station 300 that may be included in the coating equipment 230 (shown in FIG. 2). The Meyer Rod coating station may include a coating pan 310 that is configured to receive and hold the liquid coating 220, an application roller 340 that is configured to apply the liquid coating 220 from the coating pan 310 to the substrate 210, a Meyer bar 350 that is configured to allow desired quantity of the liquid coating 220 to remain on the substrate 210, and one or more rollers 360 that are configured to convey the substrate 210 in/out/through the Myer Rod coating station 300.

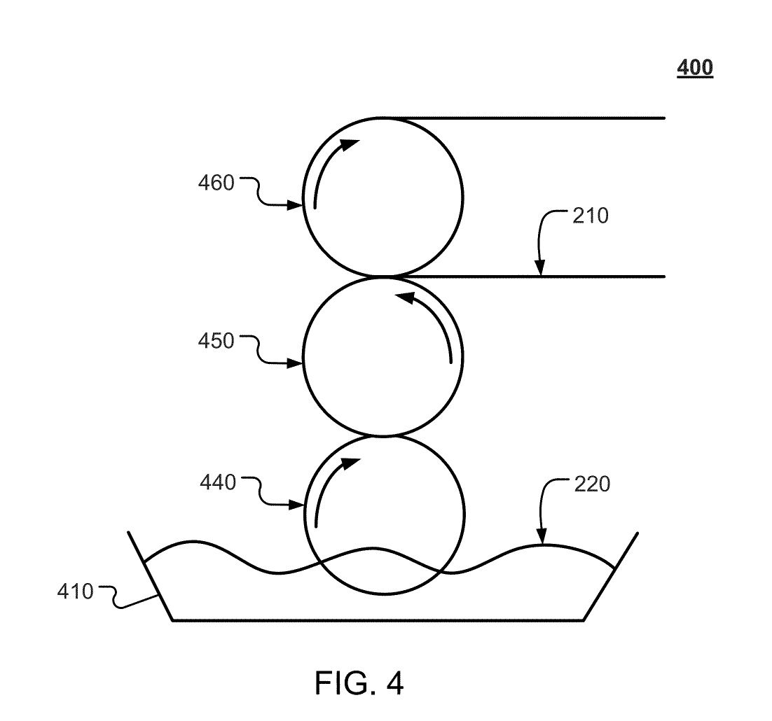

FIG. 4 shows an example of a Tenter Frame coating station 400 that may be included in the coating equipment 230 (shown in FIG. 2). The Tenter Frame coating station 400 may include a coating pan 410 that is configured to receive and hold the liquid coating 220, a fountain roller 440 that is configured to convey liquid coating 220 from the coating pan 410 to an application roller 450, an application roller 450 that is configured to receive liquid coating 220 from the fountain roller 440 and to apply the liquid coating 220 to the substrate 210; and a back-up roller 460 that is configured to convey the substrate 210 in/out/through the Tenter Frame coating station 400.

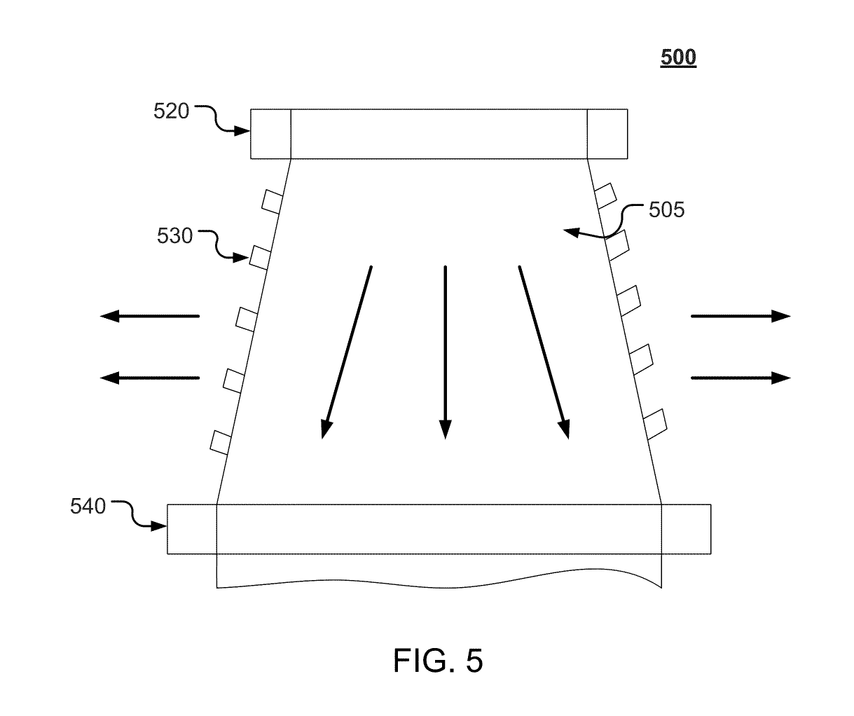

FIG. 5 shows an example of a Tenter Frame 500 that may be implemented, e.g., in the coating equipment 230 (shown in FIG. 2) to stretch e.g., a thin gauge coated clear (CC) film, the substrate 210, and the like, according to the principles of the disclosure. The Tenter Frame 500 includes at least one roller 520 that may be configured to receive a material 505 (e.g., a CC film, a substrate, and the like) and move the material down the stretching process. The Tenter Frame 500 includes at least one further roller 540 for receiving the material 505 from the roller 520 and conveying the material downstream for, e.g., further processing. The Tenter Frame 500 also includes at least one clip 530 (e.g., a stenter clip) that may be configured to apply transverse-direction orientation process onto the material 505 where the material 505 is uni-axially oriented, or stretched, in the transverse direction. The Tenter Frame 500 may be configured to receive the substrate 210 after a layer of liquid coating 220 has been applied to the substrate. Alternatively, the Tenter Frame 500 may receive the substrate 210 for stretching prior to the application of liquid coating 220 in the coating equipment (FIG. 2).

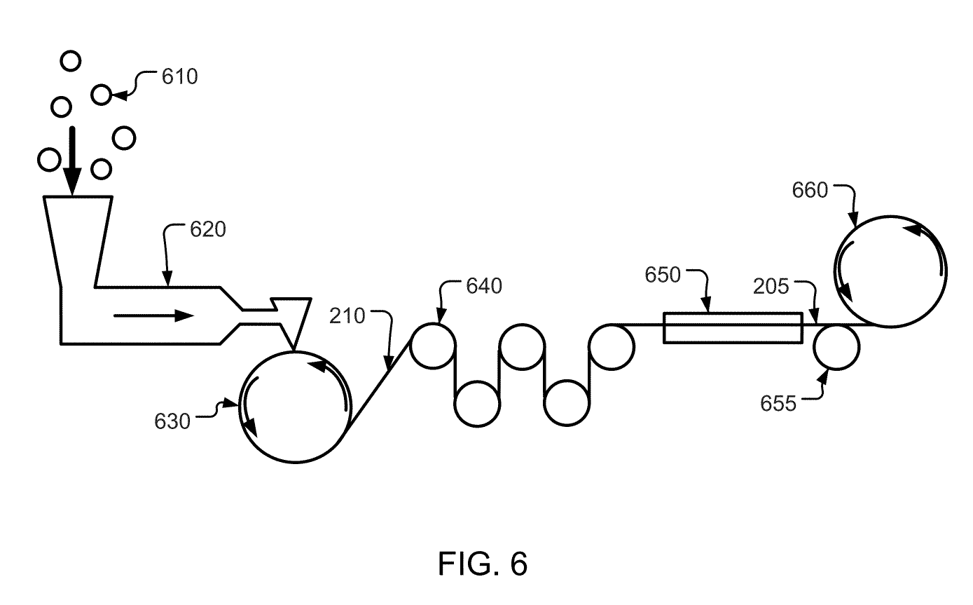

FIG. 6 shows an example of a coated clear (CC) film manufacturing line that is constructed according to the principles of the disclosure. As seen, the CC film manufacturing line may include an extruder 620, a casting drum 630, at least one machine-direction (MD) stretching roller(s) 640, and at least one transverse-direction (TD) stretching roller(s) 650, at least one cooling roller 655, and a master roll winding 660.

A polymer material 610 (e.g., thermoplastic polymer) in a form of, e.g., pellets, powder, and the like, may be fed into the extruder 620. The extruder 620 may carry out an extrusion process (e.g., cast extrusion, brown film extrusion, and the like) by which a polymer material 610 is melted and extruded onto the casting drum 630. The casting drum 630 may be configured to create a substrate 210 (e.g., TPP film web) from the melted polymer material 610. The resulting substrate 210 may then be sent to at least one MD roller 640 where the substrate 210 may be uni-axially oriented, or stretched, in the machine direction. The MD roller 640 may be heated sufficiently to bring the substrate 210 to a suitable temperature in order to stretch the substrate 210 in a machine direction. The substrate 210 may then be rapidly cooled through (e.g., colder MD roller) to set the orientation of the substrate 210. The substrate 210 may then be processed onto TD stretching roller 650, where the substrate 210 may then be uni-axially oriented, or stretched, in the transverse direction by using, e.g., the Tenter Frame 500 (FIG. 5). The Tenter Frame 500 may be heated in order to achieve a desired shrinkage.

Upon leaving the Tenter Frame 500, the substrate 210 may be cooled by passing over at least one cooling roller 655. The coater 235 (FIG. 2) may be provided upstream of and affixed to, e.g., a TD stretching roller 650, or the like, to apply a layer of liquid coating to the substrate 210 prior to stretching in TD stretching roller 650. Alternatively, the Tenter Frame 500 may be configured to receive the coated clear film 205 after the layer of liquid coating 220 has been applied. The resulting coated clear film 205 may then be sent to the master roll winding 660 which may include e.g., cutting devices for edge trimming and in-line slitting of the coated clear film 205.

The coated clear (CC) film 205 may include a thin gauge (e.g., about 25 micron to about 250 micron) coated clear film that has been cross-direction stretched by the coating equipment 230 (e.g., in a Tenter Frame), which may include the CC film manufacturing line shown in FIG. 6. The CC film 205 may exhibit known shrinkage in a controlled heated environment (e.g., like an oven), which may be suitable for, e.g., bottle and package labeling. The CC film 205 may include the substrate 210 (e.g., a thermoplastic polymer, such as, e.g., PETG, PVC, and the like) and a liquid coating 220 on the surface of the substrate 210 that will receive digital inks to allow full color printing and graphics. The liquid coating 220 has performance properties such that the CC film 205 can be high speed printed with, e.g., digital ink printers and processed into, e.g., a seamed tube (sleeve) using conventional sleeve label manufacturing processes and then affixed to the bottle or packaged product to provide labeling or protection.

An embodiment of the CC film 205 includes, e.g., a Klöckner Pentaplast (or equivalent) 50 micron thick clear transverse directional oriented PETG polymeric film with a 0.10 dry grams per square meter (gsm) coatweight of, e.g., Klöckner Pentaplast W45 coating (or equivalent). The coatweight of the applied ink receptive coating may be metered to be precise in quantity using a preferred coating methodology. The coat weight may vary by, e.g., about +/−50% using gravimetric test methods in all areas of the areas of product manufacture.

The coatweight may be applied in a range of, e.g., about 0.03 gsm to about 1.00 gsm, preferably about 0.08 gsm to about 0.16 gsm, and more preferably about 0.08 gsm to provide desired performance properties.

Alternatively (or additionally), the liquid coating 220 may include, e.g., a clear urethane, acrylic, latex, or other polymer emulsion manufactured by e.g., Michelman Digiprime, LexTech, HP Topaz, HP Sapphire, Utopia, Wausau Coated Products, Masterpiece Graphix, or the like.

Alternative substrates 210 may include, e.g., a clear transverse directional oriented PETG polymeric film, clear and colored PVC, clear and pigmented PETG, clear and pigmented APET, and multilayer constructions of any and all polymer films that exhibit heat shrink characteristics. Substrate material manufacturers may include e.g., Bonset, Fuji Film, SKC, Mitsubishi, or the like.

The article of manufacture may include the CC film 205. The CC film 205 may include certain properties and characteristics that allow for its use in, e.g., the digital printing and labeling industry. These properties include:
Clarity—the coated product (CC film), at the coating weight disclosed herein, should exhibit a light transparency and reflectance equal to or within, e.g., about +/−5% to about +/−20%, and preferably about +/−20% of the uncoated film. A 20 degree gloss level measured with ASTM D523 in a range from, e.g., about 80 to about 150, preferably about 95 to about 125, and more preferably about 110 for the cc film. The CC film should have a haze that is substantially the same as the uncoated TPP film that is included in the CC film. The CC film should exhibit haze measured with ASTM D1003 of, e.g., about 0 to about 10, preferably about 0 to about 6, and more preferably about 0 to about 3.
Coefficient of Friction—The CC film should have a coefficient of friction in a measureable range of, e.g., about 0.15 to about 0.28 using ASTM D1894
Digital Ink Blanket transfer—The CC film should have sufficient positive surface charge such that, e.g., toner-based digital inks may transfer from a print blanket to the print substrate (TPP film). RIT (Rochester Institute of Technology), HP, and others may perform the necessary tests to determine the acceptance criteria.
Ink tape test—The CC film, after printing, may pass, e.g., a 3M 601 tape test in accordance with RIT methods and criteria.
Fixing—The CC film, after printing, may allow, e.g., an ink to cure and set such that additional processes can be possible without scuffing the ink and causing ink falloff and pinholes in the image.
Seaming after coating—The CC film may process in, e.g., a commercial high speed seaming operation through Stanford, DCM, Karlville, or similar equipment, or similar, to the extent commercial solvents bond the film at speeds of, e.g., about 50 to about 200 meters per minute. The CC film may be compatible with a variety of solvents, including, e.g., THF, MEK, to the extent that a bond of the films can be tested to a level of, e.g., about 10N/cm bond strength or greater.
Block resistant—the CC film may have sufficient dry tack and hardness to resist blocking or tacking in roll form to unwind at commercial speeds without ripping out and tearing the web. The test method may include, e.g., placing stacked sheets 5×8 inch under 40 pounds pressure in an 150° F. elevated temperature environment for five days, or placing stacked sheets 5.5×8 inch under 50 pounds pressure in an 120° F. elevated temperature environment for five days, resulting in ease of removal.
Process ability—The CC film may have physical properties that will not be a detriment to, e.g., high speed label processing. This may include properties, such as, e.g., tensile, elongation, stiffness, slip, antistatic, coefficient of expansion and contraction, flammability, resistance to heat, impact strength, coefficient of friction, or the like.
Shrink curve effect minimal—The CC film may exhibit a shrink curve (% shrink vs temperature) within, e.g., about 95% of the uncoated substrate approved for this process.
Coat weight consistency—The CC film may be measured to have been applied with, e.g., a 0.10 dry gsm coatweight +/−50% using a gravimetric test method in all areas of the article of manufacture (product). Further, the applied coatweight may be in a range of, e.g., about 0.03 gsm to about 1.00 gsm, preferably in a range of about 0.08 gsm to about 0.16 gsm, and more preferably equal to about 0.08 gsm.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A liquid coating for use with digital printers that print digital images, the liquid coating comprising:
a low volatile organic compound; and
a water-based ammoniated polyurethane/acrylic blended digital print receptive coating formulation,
wherein the coating formulation further comprises a nonionic surfactant that, when coated and dried to a substrate will enable effective printing of a digital image onto the substrate.

2. The liquid coating according to claim 1, wherein the substrate comprises at least one of PET, PETG, PVC, and APET.

3. The liquid coating according to claim 1, wherein the substrate comprises a thin gauge clear film to be utilized in a shrink sleeve manufacturing process.

4. The liquid coating according to claim 1, wherein the liquid coating is coated to the substrate using at least one of the following processes:
gravure coating, reverse roll coating, gap coating, meyer rod coating, slot die coating, immersion coating, curtain coating, and air knife coating.

5. The liquid coating according to claim 1, comprising about 6.9% solids.

6. The liquid coating according to claim 1, comprising a viscosity of about 1.43 cps.

7. The liquid coating according to claim 1, wherein the coatweight of the liquid coating comprises a range of about 0.03 gsm to about 1.00 gsm

8. The liquid coating according to claim 1, wherein the liquid coating comprises a pH level in the range of about 7 pH to about 9 pH.

9. A method of manufacturing a liquid coating for use with digital printers, comprising:
providing a vessel;
introducing an appropriate amount of H₂O into the vessel;
introducing an appropriate amount of Digiprime 4431 or equivalent into the vessel;
introducing an appropriate amount of NeoCryl XK-90 or equivalent into the vessel;
mixing the contents of the vessel for a first predetermined length of time;
slowly delivering Surfynol 440 or equivalent into the vessel while mixing the contents of the vessel; and
continuing to mix the contents of the vessel for a second predetermined length of time.

10. The method of manufacturing the liquid coating according to claim 9, wherein the vessel comprises one of:
a fiber board drum and a plastic tote.

11. The method of manufacturing the liquid coating according to claim 9, wherein the H₂O is introduced into the vessel at room temperature.

12. The method of manufacturing the liquid coating according to claim 9, wherein the first predetermined length of time comprises about 10 minutes.

13. The method of manufacturing the liquid coating according to claim 9, wherein the second predetermined length of time comprises about 30 minutes.

14. The method of manufacturing the liquid coating according to claim 9, wherein the Digiprime 4431 or equivalent is filtered by a micron mesh filter prior to being introduced into the vessel.

15. The method of manufacturing the liquid coating according to claim 9, wherein the Digiprime 4431 or equivalent is introduced into the vessel by one of:
a diaphragm, a pump, and a pumping system.

16. The method of manufacturing the liquid coating according to claim 9, wherein the NeoCryl XK-90 or equivalent is filtered by a micron mesh filter prior to being introduced into the vessel.

17. The method of manufacturing the liquid coating according to claim 10, wherein the NeoCryl XK-90 or equivalent is introduced into the vessel by a releasing valve on the tote that allows raw material to gravity feed through a pre-attached corrugated hose.

18. The method of manufacturing the liquid coating according to claim 9, wherein the contents of the vessel are mixed by a mixer.

19. The method of manufacturing the liquid coating according to claim 18, wherein the mixer comprises a three blade, dual propeller mixer capable of about 1750 rpm.

20. The method of manufacturing the liquid coating according to claim 9, wherein the substrate comprises one of PET, PETG, PVC, and APET.

21. The method of manufacturing the liquid coating according to claim 9, wherein both the substrate and the liquid coating are clear when the liquid coating is applied to a surface of the substrate and is allowed to dry into a coated clear film.

22. A method of manufacturing a coated substrate, the method comprising:
conveying a substrate across a coating equipment;
applying a blended digital receptive liquid coating to the substrate; and
drying the coated substrate.

23. The method according to claim 23, wherein the liquid coating comprises Klöckner Pentaplast W45 coating.

24. The method according to claim 23, wherein the liquid coating comprises a polymer emulsion that includes one of a urethane, an acrylic, and a latex.

25. The method according to claim 22, wherein the substrate comprises one of PET, PETG, PVC, and APET.

26. The method according to claim 22, wherein the coating equipment comprises a coater that applies the liquid coating onto the substrate.

27. The method according to claim 22, wherein the coater comprises one of: A Meyer Rod, a Reverse Roll, a Three Roll Dahlgren, a Gravure coater, a Slot Die coater, a Curtain coater, a Tenter coater, and a Air Knife coater.

28. The method according to claim 22, wherein the drying the coated substrate further comprises applying sufficient BTU energy to the coated substrate.

29. The method according to claim 22, wherein the drying the coated substrate further comprises applying infrared energy to the substrate.
